(19) United States
(12) Patent Application Publication
(10) Pub. No.: US 2015/0165686 A1
(43) Pub. Date: Jun. 18, 2015

(54) THREE-DIMENSIONAL PRINTING APPARATUS

(71) Applicants: XYZprinting, Inc., New Taipei City (TW); Cal-Comp Electronics & Communications Company Limited, New Taipei City (TW); Kinpo Electronics, Inc., New Taipei City (TW)

(72) Inventors: Hua Liu, New Taipei City (TW); Hong-Chuan Yeh, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/156,472

(22) Filed: Jan. 16, 2014

(30) Foreign Application Priority Data
Dec. 12, 2013 (TW) 102145919

(51) Int. Cl. B29C 67/00; G05B 15/02

(52) U.S. Cl. CPC B29C 67/0088; G05B 15/02; B33Y 50/02

(57) ABSTRACT

A three-dimensional printing apparatus including a base, a printing unit, and a control unit is provided for forming a three-dimensional object on a forming area layer by layer with a material. The base has a body and a moving member assembled therein. The forming area covers the moving member. The control unit is electrically connected to the moving member and the printing unit. The printing unit is controlled by the control unit, wherein after the three-dimensional object is formed, the moving member is controlled by the control unit to move relative to the body, such that at least a portion of the three-dimensional object is detached from the moving member.

### CROSS-REFERENCE TO RELATED APPLICATION

This application claims the priority benefit of Taiwan application serial no. 102145919, filed on Dec. 12, 2013. The entirety of the above-mentioned patent application is hereby incorporated by reference herein and made a part of this specification.

### BACKGROUND OF THE INVENTION

1. Field of the Invention

The invention relates to a printing apparatus. More particularly, the invention relates to a three-dimensional printing apparatus.

2. Description of Related Art

With the advance in computer-aided manufacturing (CAM), the manufacturing industry has developed three-dimensional (3D) printing technology capable of rapidly fabricating original concept designs. Three-dimensional printing technology is actuality a general designation of a series of rapid prototyping (RP) techniques, and a basic principle thereof is additive manufacturing, where an RP machine forms a sectional shape of a workpiece in an X-Y plane through scanning, and intermittently shifts by a layer thickness in a Z-axis, so as to form a three-dimensional object. Three-dimensional technology is not limited to any geometric shape, and the excellence of the RP techniques is better demonstrated in more complex components. Three-dimensional printing technology can greatly save manpower and processing time, and digital three-dimensional model information designed by a three-dimensional computer-aided design (CAD) software can be realistically rendered in a short amount of time. Not only can the resulting object be touched, but the geometric curves thereof can also be truly appreciated. Moreover, the assemblability of the components can be tested, and even possible functional tests may be performed.

A fused deposition modeling (FDM) three-dimensional printing apparatus generally coats a heated and melted thermoplastic material on a base layer by layer and forms a three-dimensional object layer by layer after the thermoplastic material is cooled and hardened. Therefore, after the three-dimensional object is complete, the three-dimensional object is adhered to the base and becomes difficult to remove. As a result, how to readily remove the three-dimensional object with a simple mechanism after the three-dimensional object is formed is an issue that needs to be solved by those skilled in the art.

### SUMMARY OF THE INVENTION

The exemplary embodiment provides a three-dimensional printing apparatus. A base of the three-dimensional printing apparatus has at least one moving member, such that after a three-dimensional object is complete, the three-dimensional object can be readily removed from the base through the moving member.

The three-dimensional printing apparatus of the exemplary embodiment includes a base, a printing unit, and a control unit for forming a three-dimensional object on a forming area layer by layer with a material. The base has a body and a moving member. The control unit is electrically connected to the moving member and the printing unit. The printing unit is controlled to form the three-dimensional object on the forming area by the control unit. The forming area covers the moving member. The moving member is controlled by the control unit to move relative to the body after the three-dimensional object is formed, such that at least a portion of the three-dimensional object is detached from the moving member.

In an exemplary embodiment, the base includes a plurality of assembling members. The forming area covers at least a portion of the assembling members. After the three-dimensional object is formed, at least one of the assembling members moves relative to the body to generate a segment deviation, such that a portion of the three-dimensional object is detached from at least one of the assembling members.

In an exemplary embodiment, the assembling members are arranged along at least one direction. After the three-dimensional object is formed, the assembling members move relative to the body in sequence along the direction to generate the segment deviation.

In an exemplary embodiment, the direction is a linear direction.

In an exemplary embodiment, the direction is an arc direction.

In an exemplary embodiment, the direction is a clockwise direction or a counterclockwise direction.

In an exemplary embodiment, the assembling members are arranged in an array.

In an exemplary embodiment, at least one of the assembling members is in a fixed state relative to the other assembling members. After the three-dimensional object is formed, at least one of the other assembling members moves relative to at least one of the assembling members in the fixed state to generate the segment deviation, such that a portion of the three-dimensional object is detached from the other assembling members.

In an exemplary embodiment, a plurality of pins are further included, wherein the pins are disposed on the bottom of the base. After at least a portion of the three-dimensional object is detached from the moving member, the pins located inside the forming area are movably extended beyond the base and push the three-dimensional object away from the base.

Based on the above, in the exemplary embodiments, after a three-dimensional printing apparatus forms a three-dimensional object on a base thereof, at least a portion of the three-dimensional object can be detached from a moving member first by having the moving member of the base move relative to a body and locating the moving member inside a forming area. The adhesion between the three-dimensional object and the base is thus reduced. Accordingly, based on the principles above, the moving member is gradually detached from a portion of the three-dimensional object, resulting in the gradual decrease in adhesion between the three-dimensional object and the base, such that a user can readily remove the three-dimensional object from the base.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a three-dimensional printing apparatus according to an exemplary embodiment.

FIG. 2 is a partial schematic of the three-dimensional printing apparatus of FIG. 1.

FIG. 3 is a schematic diagram of the three-dimensional printing apparatus of FIG. 2 in another state.

FIG. 4 is a partial schematic of a three-dimensional printing apparatus according to another exemplary embodiment.

FIG. 5 is a schematic diagram of the three-dimensional printing apparatus of FIG. 4 in another state.

FIG. 6 is a partial schematic of a three-dimensional printing apparatus according to another exemplary embodiment.

FIG. 7 is a schematic diagram of the three-dimensional printing apparatus of FIG. 6 in another state.

### DESCRIPTION OF THE EMBODIMENTS

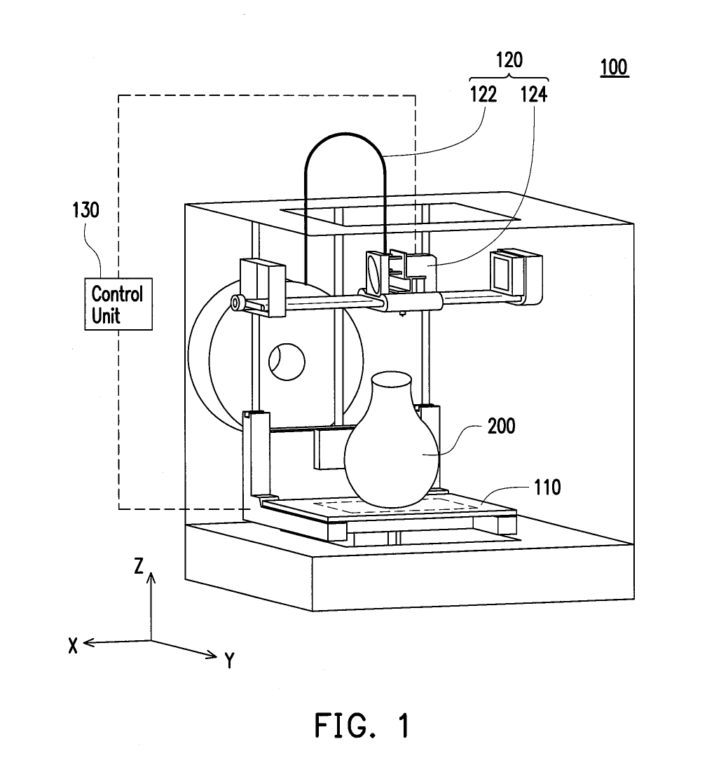

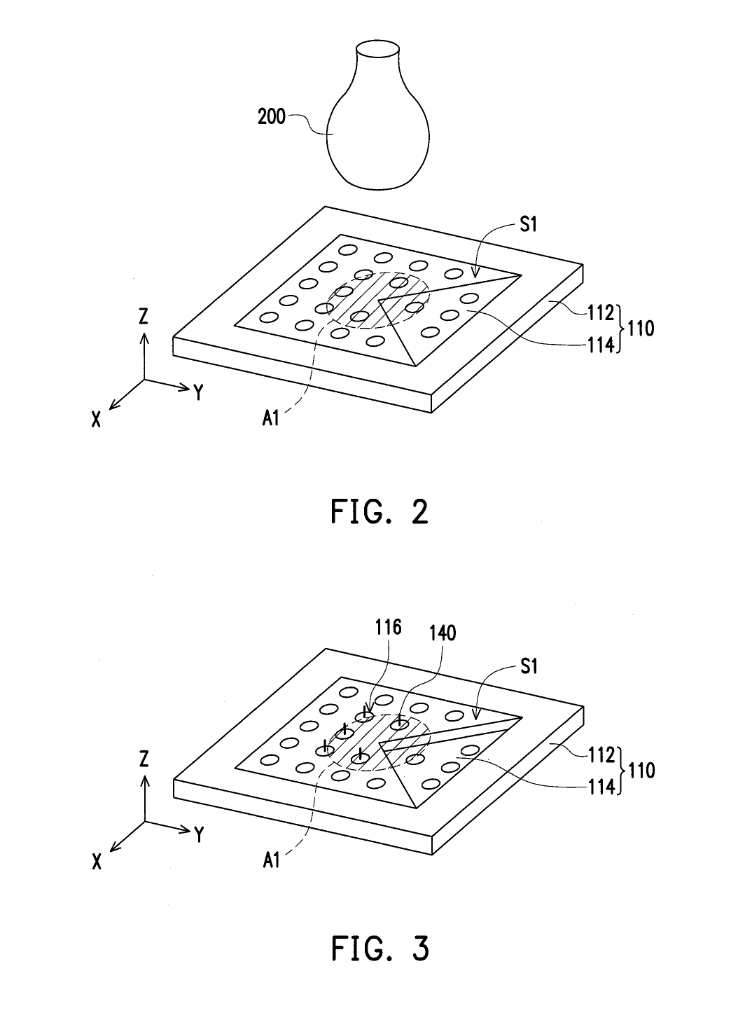

FIG. 1 is a schematic diagram of a three-dimensional printing apparatus according to an exemplary embodiment. FIG. 2 is a partial schematic of the three-dimensional printing apparatus of FIG. 1. Referring to FIG. 1 and FIG. 2, in the present embodiment, a three-dimensional printing apparatus 100 is suitable for printing a three-dimensional object 200 according to a digital three-dimensional model information. The three-dimensional printing apparatus 100 includes a base 110, a printing unit 120, and a control unit 130. In particular, the base 110 has a body 112 and a moving member 114. The control unit 130 includes relevant assemblies such as a control circuit and a processor, and the control unit 130 is electrically connected to the printing unit 120 and the moving member 114 of the base 110. In the present embodiment, the digital three-dimensional model information can be a digital three-dimensional image file constructed by, for instance, a computer-aided design (CAD) or an animation modeling software. The control unit 130 can be used to read and process the digital three-dimensional model information.

Moreover, the base 110 has a bearing surface S1 for bearing a hot meltable material sprayed by the printing unit 120. In the present embodiment, the printing unit 120 includes at least one material-supplying spool 122 coupled to a printing head 124 to provide the hot meltable material to the printing head 124. The printing head 124 is disposed above the base 110, the control unit 130 is coupled to and controls the printing head 124 to form the three-dimensional object 200 on the bearing surface Si of the base 110 layer by layer with the hot meltable material. In the present embodiment, the material-supplying spool 122 can be a solid spool formed by a hot meltable material, and the material-supplying spool 122 can, for instance, heat the solid spool through a heating unit (not shown) of the printing head 124 such that the hot meltable material is in a melting state. Next, the hot meltable material is extruded through the printing head 124 and stacked on the bearing surface S1 layer by layer from the bottom up to form a plurality of hot meltable material layers. The hot meltable material layers are stacked upon one another to form the three-dimensional object 200. In the present embodiment, the hot meltable material can be, for instance, a hot meltable polymer material such as polylactic acid (PLA) or an acrylonitrile butadiene styrene (ABS) resin. It should be mentioned that, in general, the hot meltable material printed and formed on the bearing surface S1 layer by layer through the printing head 124 can include a building material for building the three-dimensional object 200 and a support material for supporting the three-dimensional object 200. In other words, the hot meltable material printed and formed on the bearing surface S1 is not only used to form the three-dimensional object 200, but can also form a supporting portion or a base frame of the three-dimensional object 200. Moreover, after the hot meltable material printed and formed on the bearing surface S1 is solidified, the support material supporting the three-dimensional object 200 can be removed to obtain the three-dimensional object 200.

A Cartesian coordinate system is provided as a reference for the description of relevant components and the Cartesian coordinate system defines the bearing surface S1 as located on an X-Y plane. FIG. 3 is a schematic diagram of the three-dimensional printing apparatus of FIG. 2 in another state. Referring to FIG. 1 to FIG. 3, based on the above, the moving member 114 of the base 110 is coupled to and controlled by the control unit 130 and can move relative to the body 112. As shown in FIG. 3, the moving member 114 of the present embodiment can move relative to the bearing surface S1 (i.e., X-Y plane) along a Z-axis. More specifically, the three-dimensional object 200 of the present embodiment is formed in a forming area A1 (such as the shaded area shown in FIG. 2) on the bearing surface S1, and the forming area A1 covers the moving member 114. As a result, when the three-dimensional printing apparatus 100 forms the three-dimensional object 200 in the forming area A1 on the bearing surface S1, the body 112 and the moving member 114 are in actuality located at the same height (i.e., the body 112 and the moving member 114 can be considered as being formed on the bearing surface S1 together). Next, the control unit 130 moves the moving member 114 away from the bearing surface S1 by controlling the moving member 114 to move relative to the body 112 along the negative Z-axis. In other words, the moving member 114 is in a depressed state relative to the body 112, and therefore a segment deviation is generated such that a portion of the three-dimensional object 200 is detached from the moving member 114. In this way, the adhesion between the base 110 and the three-dimensional object 200 fixed on the base 110 after the material cooled down is reduced. The present embodiment omits the three-dimensional object 200 in FIG. 3 such that the movement state of the moving member 114 can be clearly identified. Subsequent embodiments are also presented in the same manner.

Moreover, in the present embodiment, the three-dimensional printing apparatus 100 further includes a plurality of pins 140 coupled to and controlled by the control unit 130 and disposed on a bottom of the base 110. The pins 140 are housed in openings 116 arranged in an array. After at least a portion of the three-dimensional object 200 is detached from the moving member 114, the pins 140 located within the range of the forming area A1 can be controlled to extend beyond the carrying surface S1 of the base 110 and push the portion of three-dimensional object 200 not yet fixed to the base 110 away from the base 110.

Based on the above, in the present embodiment, the base 110 has the moving member 114 and the moving member 114 occupies only a portion of the forming area A1, and thereby the movement of the moving member 114 is controlled and a segment deviation is generated, such that the three-dimensional object 200 is detached and the adhesion between the three-dimensional object 200 and the base 110 is reduced. Therefore, when the user removes the three-dimensional object 200, the adhesion caused by the entire forming area A1 can be avoided. As a result, in addition to requiring less effort, the risk of damaging the three-dimensional object 200 during the removal process can also be reduced.

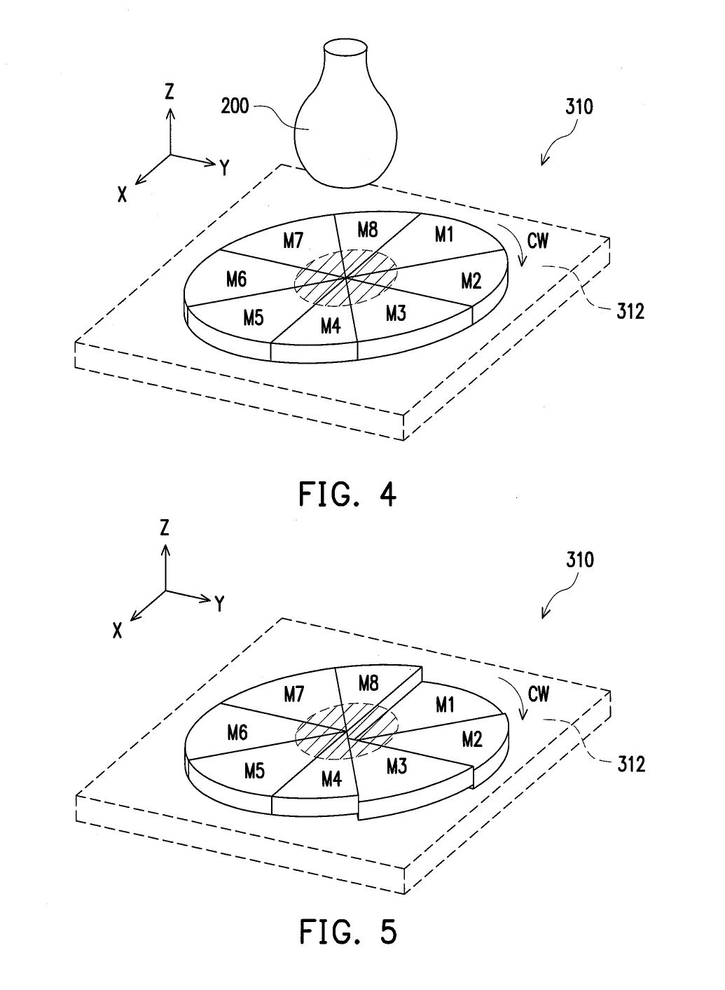

FIG. 4 is a partial schematic of a three-dimensional printing apparatus according to another exemplary embodiment. FIG. 5 is a schematic diagram of the three-dimensional printing apparatus of FIG. 4 in another state. Referring to FIG. 4 and FIG. 5, the difference between the present embodiment and the embodiments above is, a base 310 of the present embodiment has a moving member formed by a plurality of assembling members M1 to M8 (the moving member is only divided into 8 as an example, but the present embodiment does not limit the number thereof). Moreover, the assembling members M1 to M8 are arranged along an arc direction CW (i.e., clockwise direction). The forming area A1 of the three-dimensional object 200 on the base 310 covers at least a portion of the assembling members M1 to M8. Accordingly, after the three-dimensional object 200 is formed on the bearing surface S1, at least one of the assembling members M1 to M8 moves relative to a body 312 to generate a segment deviation, such that a portion of the three-dimensional object 200 is detached from at least one of the assembling members M1 to M8. The body 312 is drawn with a dotted outline such that the moving members M1 to M8 can be clearly identified. In other words, in the present embodiment, similar to the embodiment of FIG. 3, one of the moving members, such as the moving member M1, can move relative to the body 312 and the other assembling members M2 to M8 (i.e., the assembling members M2 to M8 are all in a fixed state relative to the assembling member M1), such that a portion of the three-dimensional object 200 and the assembling member M1 are detached from each other. A similar effect to the previous embodiments is thus achieved.

Moreover, as shown in FIG. 5, in the present embodiment, the assembling members M1 to M8 can also be driven to move relative to the body 312 in sequence along the direction CW (i.e., clockwise direction) to generate a segment deviation (only the relative movements of the assembling members M1 to M3 are shown as an example). Therefore, the three-dimensional object 200 can gradually be detached from the assembling members M1 to M8, such that the three-dimensional object 200 is only fixed to the assembling member M8 in the end. As a result, the user can readily remove the three-dimensional object 200 completely from the base 310 with less effort. Similarly, the direction of the relative movement of the assembling members M1 to M8 in sequence is not limited. In another embodiment not shown, the assembling members M1 to M8 can also be driven to detach from the three-dimensional object 200 in sequence along a counterclockwise direction.

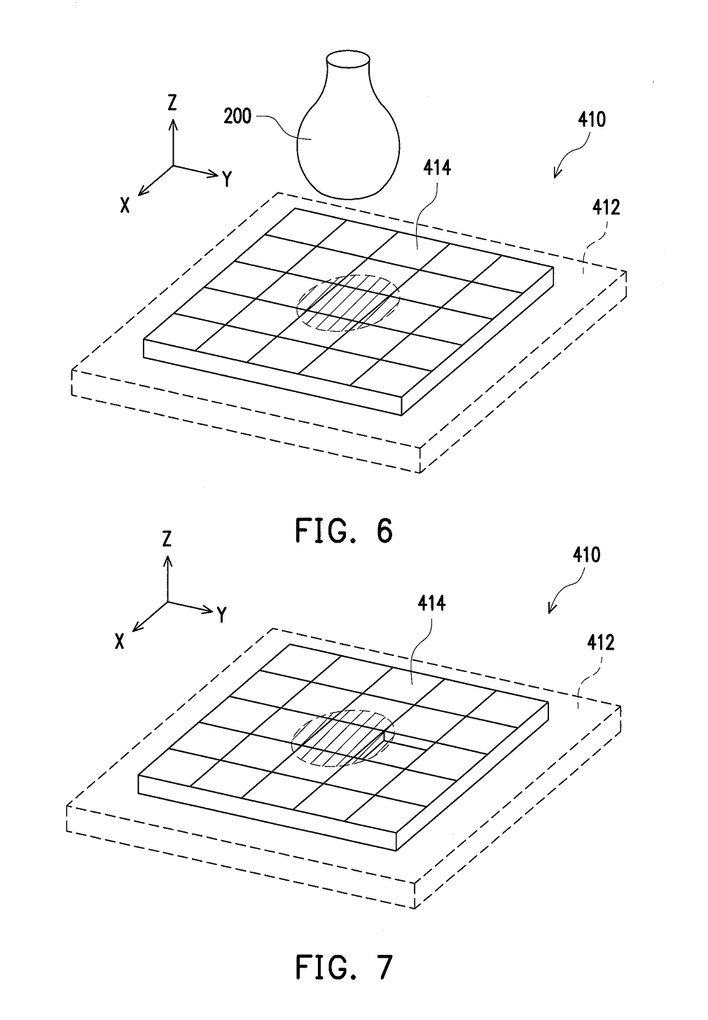

FIG. 6 is a partial schematic of a three-dimensional printing apparatus according to another exemplary embodiment. FIG. 7 is a schematic diagram of the three-dimensional printing apparatus of FIG. 6 in another state. The difference between the present embodiment and the previous embodiments is, in the present embodiment, the moving member of a base 410 includes a plurality of assembling members 414 respectively arranged (linearly) along the X-axis and the Y-axis to form an array state shown in the figure. Similarly, each of the assembling members 414 of the present embodiment can be driven by the control unit 130 (shown in FIG. 1) and move relative to the body 412 (i.e., move along the negative Z-axis) to be in a depressed state, so as to achieve the effect of gradual detachment of the three-dimensional object 200 from the base 410.

It should be mentioned that, the pins of FIG. 3 can also be applied in the embodiments of FIG. 4 to FIG. 7 such that the three-dimensional object is push away from the base through the pins after a portion of the three-dimensional object is detached from the moving member.

Based on the above, in the exemplary embodiments, after a three-dimensional printing apparatus forms a three-dimensional object on a base thereof, at least a portion of the three-dimensional object can be detached from a moving member first by having the moving member of the base move relative to a body and locating the moving member inside a forming area. The adhesion between the three-dimensional object and the base is thus reduced.

More specifically, the moving member can be formed by disposing a plurality of assembling members arranged in sequence, and the forming area of the three-dimensional object can cover at least a portion of the assembling members. Accordingly, based on the principles above, after the three-dimensional object is formed, the assembling members and a portion of the three-dimensional object can be gradually detached from each other so as to gradually decrease the adhesion between the three-dimensional object and the base. Lastly, the user can readily remove the three-dimensional object from the base through pins or other tools.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A three-dimensional printing apparatus for forming a three-dimensional object on a forming area layer by layer with a material, the three-dimensional printing apparatus comprising:
a base having a body and a moving member assembled therein, wherein the forming area covers the moving member;
a printing unit; and
a control unit electrically connected to the moving member and the printing unit, wherein the printing unit is controlled to form the three-dimensional object on the forming area by the control unit, and the moving member is controlled by the control unit to move relative to the body after the three-dimensional object is formed, such that at least a portion of the three-dimensional object is detached from the moving member.

2. The three-dimensional printing apparatus of claim 1, wherein the moving member comprises a plurality of assembling members, the forming area covers at least a portion of the assembling members, and after the three-dimensional object is formed, at least one of the assembling members moves relative to the body to generate a segment deviation, such that a portion of the three-dimensional object is detached from at least one of the assembling members.

3. The three-dimensional printing apparatus of claim 2, wherein the assembling members are arranged along at least one direction, and the assembling members move relative to the body in sequence along the direction to generate the segment deviation after the three-dimensional object is formed.

4. The three-dimensional printing apparatus of claim 3, wherein the direction is a linear direction.

5. The three-dimensional printing apparatus of claim 3, wherein the direction is an arc direction.

6. The three-dimensional printing apparatus of claim 5, wherein the direction is a clockwise direction or a counterclockwise direction.

7. The three-dimensional printing apparatus of claim 5, wherein the assembling members are arranged in an array.

8. The three-dimensional printing apparatus of claim 3, wherein at least one of the assembling members is in a fixed state relative to the other assembling members, and at least one of the other assembling members moves relative to at least one of the assembling members in the fixed state to generate the segment deviation after the three-dimensional object is formed, such that a portion of the three-dimensional object is detached from the other assembling members:

9. The three-dimensional printing apparatus of claim 1, further comprising:
a plurality of pins disposed on a bottom of the base, wherein the pins located inside the forming area are movably extended beyond the base and push the three-dimensional object away from the base after at least a portion of the three-dimensional object is detached from the moving member.
